(19) United States
(12) Patent Application Publication
(10) Pub. No.: US 2024/0284556 A1
(43) Pub. Date: Aug. 22, 2024

(54) CONFIGURING USER EQUIPMENT FOR MULTICAST RECEPTION IN TELECOMMUNICATION NETWORK

(71) Applicant: Samsung Electronics Co., Ltd., Suwon-si (KR)

(72) Inventors: Vijay Kumar SHRIVASTAVA, Bangalore (IN); Sangkyu BAEK, Suwon-si (KR)

(21) Appl. No.: 18/442,793

(22) Filed: Feb. 15, 2024

(30) Foreign Application Priority Data
Feb. 16, 2023 (IN) 202341010484
Jan. 26, 2024 (IN) 2023 41010484

(51) Int. Cl. H04W 76/40; H04W 36/08; H04W 76/19; H04W 76/20; H04W 76/30

(52) U.S. Cl. CPC H04W 76/40; H04W 36/08; H04W 76/19; H04W 76/20; H04W 76/30

(57) ABSTRACT

The disclosure relates to a fifth generation (5G) or sixth generation (6G) communication system for supporting a higher data transmission rate. A method performed by a user equipment (UE) in a wireless communication system is provided. The method comprises receiving, from a base station, a radio resource control (RRC) release message including multicast broadcast services (MBS) configuration information and multicast control channel (MCCH) configuration information, wherein the MBS configuration information includes at least one of a list of neighboring cells, a group-radio network temporary identifier (G-RNTI), or an MBS session identity (ID), and the MCCH configuration information is associated with reception of a MBS multicast in an RRC inactive state and in case that a multicast session that the UE joined is not provided for the RRC inactive state in a current cell, performing an RRC connection resume.

### CROSS-REFERENCE TO RELATED APPLICATION(S)

This application is based on and claims priority under 35 U.S.C. § 119(a) of an Indian Provisional patent application number 202341010484, filed on Feb. 16, 2023, in the Indian Patent Office, and of an Indian Complete patent application number 202341010484, filed on Jan. 26, 2024, in the Indian Patent Office, the disclosure of each of which is incorporated by reference herein in its entirety.

### BACKGROUND

### 1. Field

The disclosure relates to a wireless communication system. More particularly, the disclosure relates to configuring User Equipment (UEs) for multicast reception in a telecommunication network.

### 2. Description of Related Art

Fifth generation (5G) mobile communication technologies define broad frequency bands such that high transmission rates and new services are possible, and can be implemented not only in “Sub 6 GHz” bands such as 3.5 GHZ, but also in “Above 6 GHz” bands referred to as millimeter-wave (mmWave) including 28 GHz and 39 GHZ. In addition, it has been considered to implement sixth generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method, network apparatus, and UE for configuring multicast reception in a telecommunication network for configuring UEs for multicast reception in a telecommunication network.

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system is provided. The method comprises receiving, from a base station, a radio resource control (RRC) release message including multicast broadcast services (MBS) configuration information and multicast control channel (MCCH) configuration information, wherein the MBS configuration information includes at least one of a list of neighboring cells, a group-radio network temporary identifier (G-RNTI), or an MBS session identity (ID), and the MCCH configuration information is associated with reception of a MBS multicast in an RRC inactive state and in case that a multicast session that the UE joined is not provided for the RRC inactive state in a current cell, performing an RRC connection resume.

In accordance with another aspect of the disclosure, a user equipment (UE) in a wireless communication system is provided. The UE comprises a transceiver and a controller coupled with the transceiver and configured to receive, from a base station, a radio resource control (RRC) release message including multicast broadcast services (MBS) configuration information and multicast control channel (MCCH) configuration information, wherein the MBS configuration information includes at least one of a list of neighboring cells, a group-radio network temporary identifier (G-RNTI), or an MBS session identity (ID), and the MCCH configuration information is associated with reception of a MBS multicast in an RRC inactive state, and in case that a multicast session that the UE joined is not provided for the RRC inactive state in a current cell, perform an RRC connection resume.

In accordance with another aspect of the disclosure, a method performed by a base station in a wireless communication system is provided. The method comprises transmitting, to a user equipment (UE), a radio resource control (RRC) release message including multicast broadcast services (MBS) configuration information and multicast control channel (MCCH) configuration information, wherein the MBS configuration information includes at least one of a list of neighboring cells, a group-radio network temporary identifier (G-RNTI), or an MBS session identity (ID), and the MCCH configuration information is associated with reception of a MBS multicast in an RRC inactive state and receiving, from the UE, a message for an RRC connection resume, in case that a multicast session that the UE joined is not provided for the RRC inactive state in a current cell.

In accordance with another aspect of the disclosure, a base station in a wireless communication system is provided. The base station comprises a transceiver and a controller coupled with the transceiver and configured to transmit, to a user equipment (UE), a radio resource control (RRC) release message including multicast broadcast services (MBS) configuration information and multicast control channel (MCCH) configuration information, wherein the MBS configuration information includes at least one of a list of neighboring cells, a group-radio network temporary identifier (G-RNTI), or an MBS session identity (ID), and the MCCH configuration information is associated with reception of a MBS multicast in an RRC inactive state, and receive, from the UE, a message for an RRC connection resume, in case that a multicast session that the UE joined is not provided for the RRC inactive state in a current cell.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with in the accompanying drawings, in which:

FIG. 1 is a sequence diagram that illustrates a process of configuring UE by the network apparatus for multicast service in the telecommunication network, according to an embodiment of the disclosure;

FIG. 2A is a block diagram that illustrates a UE configured for multicast reception in the telecommunication network, according to an embodiment of the disclosure;

FIG. 2B is a block diagram that illustrates a network apparatus for configuring the UE for multicast reception in the telecommunication network, according to an embodiment of the disclosure;

FIG. 3 is a flow diagram that illustrates a method to configure by a UE for multicast reception in a telecommunication network, according to an embodiment of the disclosure; and

FIG. 4 is a flow diagram that illustrates a method for configuring by network apparatus UEs for multicast reception in a telecommunication network, according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As is traditional in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits constituting a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features and it is understood that the embodiments presented herein are not limited by the accompanying drawings. As such, the proposed method is construed to extend to any alterations, equivalents and substitutes in addition to those which are particularly set out in the accompanying drawings. Although the terms first, second, etc. used herein to describe various elements, these elements are not be limited by these terms. These terms are generally used to distinguish one element from another.

Accordingly, the embodiments disclose a method for configuring a UE for multicast reception in a telecommunication network. The method includes receiving, by the UE, at least one RRC reconfiguration message or RRC release message from a network apparatus, when the UE is in a RRC CONNECTED state. The RRC reconfiguration message or the RRC release message comprises at least one of multicast MBS (Multicast Broadcast Service) Control Channel (MCCH) configuration information and one or more multicast MBS Radio Bearer (MRB) configurations that can be received in a RRC INACTIVE state. Further the method includes transiting the UE from the RRC CONNECTED state to the RRC INACTIVE state. Further, the method includes configure a multicast MCCH channel using the multicast MCCH channel configuration information. Furthermore, the method includes receiving, by the UE, a MCCH information and the one or more multicast MRB configurations through a MCCH. The MCCH information comprises an indication about presence or absence of the one or more multicast MRB configurations and a change in the one or more multicast MRB configurations. Furthermore, the method includes obtaining the one or more multicast MRB configurations provided through the MCCH channel by mapping with the stored one or more multicast MRB configurations. Also, the method includes continuing the multicast reception in the RRC INACTIVE state using the one or more multicast MRB configurations, when change in the one or more multicast MRB configurations is indicated in the MCCH information. Moreover, the method includes continuing the multicast reception using the stored one or more multicast MRB configurations, when there is no change in the one or more multicast MRB configurations is indicated in the MCCH information.

Accordingly, the embodiments disclose a method for configuring a UE for multicast reception in a telecommunication network. The method includes transmitting, by a network apparatus, at least one RRC reconfiguration message or RRC release message, when the UE is in a RRC CONNECTED state. The RRC reconfiguration message or the RRC release message comprises at least one of multicast MBS (Multicast Broadcast Service) Control Channel (MCCH) channel configuration information and one or more multicast MBS Radio Bearer (MRB) configurations that can be received in a RRC INACTIVE state. Further, the method includes transmitting, by the network apparatus, the UE 101 from the RRC CONNECTED state to the RRC INACTIVE state. Further, the method includes transmitting, by the network apparatus, a multicast MCCH information and the one or more multicast MRB configurations through a multicast MCCH channel, when the UE is in a RRC INAACTIVE. The multicast MCCH information comprises an indication about presence or absence of the one or more multicast MRB configurations and a change in the one or more multicast MRB configurations. Furthermore, the method includes performing, by the network apparatus, multicast MCCH transmission and multicast transmission to a group of UEs configured to receive multicast session when the UE is in the RRC INACTIVE state.

Accordingly, the embodiment herein is to provide a UE for configuring a UE for multicast reception in a telecommunication network. The UE comprises a processor and a communication management controller which is coupled to the processor. The communication management controller is configured to receive at least one RRC reconfiguration message or RRC release message from a network apparatus, when the UE is in a RRC CONNECTED state. The RRC reconfiguration message or the RRC release message comprises at least one of multicast MBS (Multicast Broadcast Service) Control Channel (MCCH) channel configuration information and one or more multicast MBS Radio Bearer (MRB) configurations that can be received in a RRC INACTIVE state. Further, the communication management controller transits the UE from the RRC CONNECTED state to the RRC INACTIVE state. Further, the communication management controller transits the UE from the RRC CONNECTED state to the RRC INACTIVE state. Furthermore, the communication management controller receives a multicast MCCH information and the one or more multicast MRB configurations through a multicast MCCH. The multicast MCCH configuration information comprises an indication about presence or absence of the one or more multicast MRB configurations and a change in the one or more multicast MRB configurations. Further, the communication management controller obtains the one or more multicast MRB configurations provided through the multicast MCCH channel by mapping with the stored one or more multicast MRB configurations, and continues the multicast reception in the RRC INACTIVE state using the one or more multicast MRB configurations, when change in the one or more multicast MRB configurations is indicated in the multicast MCCH information. Also, the communication management controller continues the multicast reception using the stored one or more multicast MRB configurations, when there is no change in the one or more multicast MRB configurations is indicated in the MCCH information.

Accordingly, the embodiment herein is to provide a network apparatus for configuring a UE for multicast reception in a telecommunication network. The network apparatus comprises a processor and a communication management controller. The communication management controller of the network apparatus is configured to transmit at least one RRC reconfiguration message or RRC release message, when the UE is in a RRC CONNECTED state. The RRC reconfiguration message or the RRC release message comprises at least one of multicast MBS (Multicast Broadcast Service) Control Channel (MCCH) channel configuration information and one or more multicast MBS Radio Bearer (MRB) configurations that can be received in a RRC INACTIVE state. Further, the communication management controller transits the UE from the RRC CONNECTED state to the RRC INACTIVE state. Further, the communication management controller transmits a multicast MCCH information and the one or more multicast MRB configurations through a multicast MCCH channel, when the UE is in a RRC INAACTIVE. The multicast MCCH information comprises an indication about presence or absence of the one or more multicast MRB configurations and a change in the one or more multicast MRB configurations. Furthermore, the communication management controller performs multicast MCCH transmission and multicast transmission to a group of UEs configured to receive multicast session when the UE is in the RRC INACTIVE state.

In the legacy system the UE can receive multicast service only in the RRC CONNECTED state. However, the UE cannot receive the multicast service in the RRC INACTIVE state. Also, some of the UE is capable to receive the multicast service in RRC INACTIVE state. However, when the multicast configuration is updated, the UE must switch from RRC INACTIVE state to the RRC CONNECTED state to receive the updated multicast configuration.

The proposed solution provides a method for configuring the UE to operate for multicast services in the RRC INACTIVE. Further, the proposed solution provides a method to configure the UE within the RRC INACTIVE state in order to enable them to receive the multicast service in the RRC INACTIVE state without needing a transition to RRC CONNECTED state when the multicast configurations are changed.

The New Radio Multicast Broadcast Service (NR MBS) is designed to offer multicast services where intended common contents are targeted to a group of User Equipment (UEs), which have joined the multicast group in the multicast coverage area and broadcast services where intended contents may be targeted to all the UEs in the broadcast coverage area. This coverage area can be one radio cell or larger.

In a legacy system (specifically, third generation partnership project (3GPP) Release 17 MBS), multicast services were only accessible to UEs in the RRC CONNECTED state. To address this limitation and inform UEs in the RRC IDLE or RRC INACTIVE state about the multicast session activations, a group notification or group paging mechanism is employed. Upon receiving this paging, the UE transits to the RRC CONNECTED state and starts to receive the multicast session. However, in newer systems such as 3GPP Release 18 MBS, there may be UEs capable of receiving multicast sessions even in the RRC INACTIVE state.

A potential concern arises with regards to UEs that are capable of receiving MBS multicast service while in the RRC INACTIVE state. In the past, multicast service could only be received while in the RRC CONNECTED state, and multicast configurations were made available through dedicated signaling in this state. However, there is currently no approach to receive multicast configurations while the UE is in the RRC INACTIVE state.

Even if a UE stores multicast configurations from the RRC CONNECTED state and continues to receive the multicast session while in the RRC INACTIVE state using these stored configurations, there is an issue when the multicast configurations are updated by the network. In such cases, the UE is unable to receive the multicast session while in the RRC INACTIVE state, and must transition back to the RRC CONNECTED state just to receive updated configurations.

This transition from RRC INACTIVE to RRC CONNECTED state results in increased network load and congestion, as well as increased UE power consumption and complexity.

Thus, it is desired to address the above-mentioned disadvantages or other shortcomings or at least provide a useful alternative to configure the UE for handling multicast service reception in RRC INACTIVE state.

The principal object of the embodiments herein is to provide a method, network apparatus and UE for configuring multicast reception in a telecommunication network.

Another aspect of the disclosure herein is to configure UEs for New Radio Multicast Broadcast Service (NR MBS) multicast service reception, wherein the UE can receive the multicast service in the RRC INACTIVE state.

Another aspect of the disclosure herein is to configure UEs within the RRC INACTIVE state with the ability to receive multicast services without necessitating a transition to the RRC CONNECTED state, even as the multicast configurations are changed.

In an aspect of the disclosure, the objectives are achieved by providing a method for configuring a User Equipment (UE) for multicast reception in a telecommunication network. The method includes receiving, by the UE, at least one Radio Resource Control (RRC) reconfiguration message or RRC release message from a network apparatus, when the UE is in a RRC CONNECTED state. The RRC reconfiguration message or the RRC release message comprises at least one of multicast MBS (Multicast Broadcast Service) Control Channel (MCCH) channel configuration information and one or more multicast MBS Radio Bearer (MRB) configurations that can be received in a RRC INACTIVE state. Further the method includes transiting, by the UE, from the RRC CONNECTED state to the RRC INACTIVE state. Further the method includes configuring, by the UE, a multicast MCCH channel using the multicast MCCH channel configuration information. Furthermore, the method includes receiving, by the UE, a multicast MCCH information and the one or more multicast MRB configurations through a multicast MCCH channel. The multicast MCCH information comprises an indication about presence or absence of the one or more multicast MRB configurations and a change in the one or more multicast MRB configurations. Furthermore, the method includes obtaining the one or more multicast MRB configurations provided through the multicast MCCH channel by mapping with the stored one or more multicast MRB configurations. Also, the method includes continuing the multicast reception in the RRC INACTIVE state using the one or more multicast MRB configurations, when change in the one or more multicast MRB configurations is indicated in the multicast MCCH information. Moreover, the method includes continuing the multicast reception in the RRC INACTIVE state using the stored one or more multicast MRB configurations, when there is no change in the one or more multicast MRB configurations is indicated in the multicast MCCH information.

In an embodiment, the method includes storing, by the UE, the one or more multicast MRB configurations for the multicast reception in the RRC INACTIVE state, received from the network apparatus. Further, the method includes skipping, by the UE, suspending the one or more multicast MRBs that are configured for the multicast reception in the RRC INACTIVE state. Furthermore, the method includes performing, by the UE, suspending one or more multicast MRBs that are not configured for multicast reception in the RRC INACTIVE state.

In an embodiment, the indication about the presence or absence of the one or more multicast MRB configurations and the change in the one or more multicast MRB configurations is provided based on indication of change in the multicast MCCH information.

In an embodiment, the change in the multicast MCCH information is provided in the multicast MCCH change notification DCI message, wherein the change in multicast MCCH information is indicated using at least one bit (for example, using a single bit).

In an embodiment, the multicast MCCH information comprises at least one of an identifier field, bits, a bit map to indicate the presence or absence of the one or more multicast MRB configurations, the one or more multicast MRB configurations, a multicast session activation, multicast session deactivation, multicast session release, multicast session configuration change, need for a RRC state change for the multicast session, list of neighboring cells that provides same multicast sessions as provided in the current serving cell, and congestion indication.

In an embodiment, the method includes receiving, by the UE, multicast MCCH channel configuration information for configuring the multicast MCCH channel in the RRC Release message while the UE is in the RRC CONNECTED state. The multicast MCCH channel configuration information comprises at least one parameter of MCCH modification period, repetition period, start, offset, and duration.

In an embodiment, the one or more multicast MRB configurations is associated with a multicast configuration identity for each of a multicast session, wherein the multicast configuration identity comprises at least one of a Group Radio Network Temporary Identifier (G-RNTI), Temporary Mobile Group Identity (TMGI) and Group Configured Scheduling Radio Network Temporary Identifier (G-CS-RNTI).

In an embodiment, the method of mapping of the one or more multicast MRBs in the multicast MCCH channel and the stored one or more multicast MRBs comprises mapping, by the UE, at least one of a multicast configuration identity associated with each of the multicast session, G-RNTI, TMGI and G-CS-RNTI of the one or more multicast MRB configurations in the MCCH channel with the at least one of a multicast configuration identity associated with each of the multicast session, G-RNTI, TMGI and G-CS-RNTI of the stored one or more multicast MRB configurations.

In an embodiment, the method includes receiving, by the UE, coverage area information from the network apparatus. The coverage area information comprises list of cells, Radio Access Network (RAN) based Notification Area (RNA) and the list of neighboring cells that is providing the multicast session as provided in the current serving cell. Further, the method includes releasing, by the UE, the one or more multicast MRB configurations during a cell selection or reselection in at least one of when the selected cell or reselected cell does not support the multicast reception in the RRC INACTIVE state, selected cell or reselected cell is outside coverage area of the multicast session, transition to the RRC IDLE state, and transition to the RRC CONNECTED state. Furthermore, the method includes acquiring, by the UE, the multicast MCCH channel configuration information during the cell selection or reselection to the cell which is providing the same multicast session as provided in the current serving cell, when the UE in the RRC INACTIVE state.

In an embodiment the method includes, performing one of upon receiving the RRC release message, skipping by the UE, the cell selection and continuing the multicast reception in a current serving cell. Further, the method includes performing, by the UE, the cell selection or reselection by prioritizing the serving cell; and continuing the multicast reception in the current serving cell when in RRC INACTIVE state. Also, the method includes performing, by the UE, the cell selection or reselection by selecting from a list of neighboring cells that provides same multicast sessions as provided in the current serving cell; and continuing the multicast reception in the selected or reselected cell when in RRC INACTIVE state. Moreover, the method includes performing, by the UE, the cell selection or reselection within coverage area of the multicast session and continuing the multicast reception in the selected or reselected cell when in RRC INACTIVE state. Furthermore, the method includes performing, by the UE a transition from the RRC INACTIVE state to RRC CONNECTED state to continue the multicast reception in case that the selected or reselected cell is not in the coverage area of the multicast session.

Accordingly, the embodiment herein is to provide a method for configuring a User Equipment (UEs) for multicast reception in a telecommunication network. The method includes transmitting, by a network apparatus, at least one RRC reconfiguration message or RRC release message, when the UE is in a RRC CONNECTED state. The RRC reconfiguration message or the RRC release message comprises at least one of multicast MBS (Multicast Broadcast Service) Control Channel (MCCH) channel configuration information and one or more multicast MBS Radio Bearer (MRB) configurations that can be received in a RRC INACTIVE state. Further, the method includes transiting, by the network apparatus, the UE from the RRC CONNECTED state to the RRC INACTIVE state. Further, the method includes transmitting, by the network apparatus, a multicast MCCH information and the one or more multicast MRB configurations through a multicast MCCH channel, when the UE is in a RRC INACTIVE state. The MCCH information comprises an indication about presence or absence of the one or more multicast MRB configurations and a change in the one or more multicast MRB configurations. Furthermore, the method includes performing, by the network apparatus, multicast MCCH transmission and multicast transmission to a group of UEs configured to receive multicast session when the UE is in the RRC INACTIVE state.

In an embodiment the method of transmitting, by the network apparatus, the multicast MCCH information and the one or more multicast MRB configurations comprises providing, by the network apparatus, an indication for change in the multicast MCCH information using a multicast MCCH change notification Downlink Control Information (DCI). Further, the method includes assigning, by the network apparatus, a unique multicast configuration identity to each of the one or more multicast MRB configuration. Also, the method includes including, by the network apparatus, an indication of the change in the one or more multicast MRB configurations or about absence or presence of the one or more multicast MRB configurations and a unique multicast configuration identity to each of the one or more multicast MRB configuration in the multicast MCCH information.

In an embodiment the method includes transmitting, by the network apparatus, one or more multicast MCCH configuration information for configuring the MCCH channel while the UE is in the RRC CONNECTED state. The one or more multicast MCCH configuration information comprises at least one parameter of multicast MCCH modification period, repetition period, start, offset, and duration.

In an embodiment, the method includes transmitting, by the network apparatus, coverage area information to the UE. The coverage area information comprises list of cells and the list of neighboring cells that is providing the multicast session in serving cell.

In an embodiment, the multicast MCCH information comprises at least one of an identifier field, bits, a bit map to indicate the presence or absence of the one or more multicast MRB configurations, the one or more multicast MRB configurations, a multicast session activation, multicast session deactivation, multicast session release, multicast session configuration change, need for a RRC state change for the multicast session, list of neighboring cells that provides same multicast sessions as provided in the current serving cell, and congestion indication.

Accordingly, the embodiment herein is to provide a user equipment for multicast reception in a telecommunication network. The UE comprises a processor and a communication management controller which is coupled to the processor. The communication management controller is configured to receive at least one Radio Resource Control (RRC) reconfiguration message or RRC release message from a network apparatus, when the UE is in a RRC CONNECTED state. The RRC reconfiguration message or the RRC release message comprises at least one of multicast MBS (Multicast Broadcast Service) Control Channel (MCCH) channel configuration information and one or more multicast Radio Bearer (MRB) configurations that can be received in a RRC INACTIVE state. Further, the communication management controller transits the UE from the RRC CONNECTED state to the RRC INACTIVE state. Further, the communication management controller configures a multicast MCCH channel using the multicast MCCH channel configuration information. Furthermore, the communication management controller receives a multicast MCCH information and the one or more multicast MRB configurations through a multicast MCCH. The multicast MCCH configuration information comprises an indication about presence or absence of the one or more multicast MRB configurations and a change in the one or more multicast MRB configurations. Further, the communication management controller obtains the one or more multicast MRB configurations provided through the multicast MCCH channel by mapping with the stored one or more multicast MRB configurations, and continues the multicast reception in the RRC INACTIVE state using the one or more multicast MRB configurations, when change in the one or more multicast MRB configurations is indicated in the multicast MCCH information. Also, the communication management controller continues the multicast reception using the stored one or more multicast MRB configurations, when there is no change in the one or more multicast MRB configurations is indicated in the multicast MCCH information.

Accordingly, the embodiment herein is to provide a network apparatus for multicast reception in a telecommunication network. The network apparatus comprises a processor and a communication management controller. The communication management controller of the network apparatus is configured to transmit at least one RRC reconfiguration message or RRC release message, when the UE is in a RRC CONNECTED state. The RRC reconfiguration message or the RRC release message comprises at least one of multicast MBS (Multicast Broadcast Service) Control Channel (MCCH) channel configuration information and one or more multicast MBS Radio Bearer (MRB) configurations that can be received in a RRC INACTIVE state. Further, the communication management controller transits the UE from the RRC CONNECTED state to the RRC INACTIVE state. Further, the communication management controller transmits a multicast MCCH information and the one or more multicast MRB configurations through a multicast MCCH, when the UE is in a RRC INACTIVE. The multicast MCCH information comprises an indication about presence or absence of the one or more multicast MRB configurations and a change in the one or more multicast MRB configurations. Furthermore, the communication management controller performs multicast MCCH transmission and multicast transmission to a group of UEs configured to receive multicast session when the UE is in the RRC INACTIVE state.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications be made within the scope of the embodiments herein.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

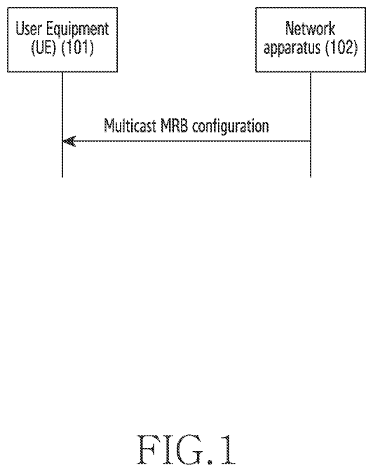

FIG. 1 is a sequence diagram that illustrates a process of configuring UE by the network apparatus for multicast service in the telecommunication network according to an embodiment of the disclosure.

The telecommunication network is a group of interconnected communication devices and systems that allow information to be exchanged over long distances. Further, a wireless communication network is a type of telecommunication network that provides wireless communication over a wide area using a network of base stations. The wireless communication networks include various technologies such as second generation (2G), third generation (3G), fourth generation (4G), 5G, 6G enabling mobile services and data services.

The proposed solution pertains to wireless communications utilizing 5G technology, as illustrated in FIG. 1. The network apparatus 102 configures the UE 101 for multicast service reception and transmits either an RRC reconfiguration message or RRC release message to the UE 101. The RRC reconfiguration message contains multicast MBS (Multicast Broadcast Service) Control Channel (MCCH) channel configuration information and one or more multicast MRB configurations that can be received while the UE 101 is in RRC INACTIVE state. Moreover, the UE 101 transitions from the RRC CONNECTED state to the RRC INACTIVE state. The network apparatus 102 also transmits multicast MCCH information and the one or more multicast MRB configurations through multicast MCCH channel. The MCCH information includes an indication of the presence or absence of the one or more multicast MRB configurations, as well as any changes in the configurations. Upon receiving the MCCH information, the UE 101 obtains the new multicast MRB configurations in case that there is an indication of a change. The UE 101 continues to receive multicast transmissions from the network apparatus 102 using the new multicast MRB configurations. However, in case that there is no indication of a change, the UE 101 continues to receive multicast transmissions using the stored multicast MRB configurations.

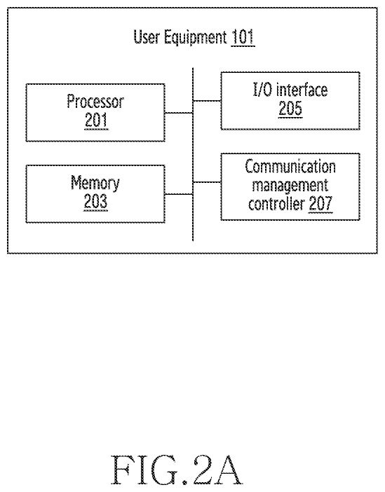

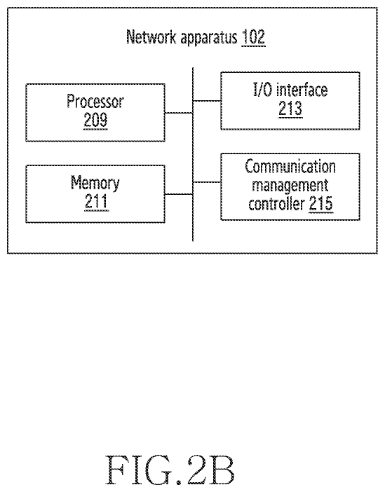

FIG. 2A is a block diagram that illustrates a UE configured for multicast service in the telecommunication network, according to the embodiment of the disclosure.

The UE 101 includes a processor 201, memory 203, an input/output (I/O) interface 205 and a communication management controller 207. The UE 101 can be an end-user device that connects with a communication network to access services. For example, the UE 101 can include, but not limited to a mobile phone, a smart phone, tablets, laptops, television, connected car, Internet of Things (IoT) devices. Further, the processor 201 of the UE 101 communicates with the memory 203, the I/O interface 107 and the communication management controller 207. The processor 201 is configured to execute instructions stored in the memory 203 and to perform various processes. The processor 201 can include one or a plurality of processors, can be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

Further, the memory 203 of the UE 101 includes storage locations to be addressable through the processor 201. The memory 203 is not limited to a volatile memory 203 and/or a non-volatile memory 203. Further, the memory 203 can include one or more computer-readable storage media. The memory 203 can include non-volatile storage elements. For example, non-volatile storage elements can include magnetic hard discs, optical discs, floppy discs, flash memories, or forms of electrically programmable memories (EPROM) or electrically erasable and programmable (EEPROM) memories. The memory 203 can store the media streams such as audios stream, video streams, haptic feedbacks and the like. The memory 203 stores one or more multicast MRB configurations received from the network apparatus 102. In some embodiment, the memory 203 stores several information included in one or more signaling messages transmitted by the network apparatus 102 to perform the multicast services in the RRC INACTIVE state.

The I/O interface 205 transmits the information between the memory 203 and external peripheral devices. The peripheral devices are the input-output devices associated with the UE 101. The I/O interface 205 receives several information from the network apparatus 102. The several information received from the network apparatus 102 can include but not limited to multicast MBS Radio bearer (MRB) configurations, and multicast MCCH configuration information, multicast MCCH information.

The communication management controller 207 communicates with the I/O interface 107 and memory 203 for operating multicast services configured by the network apparatus 102 in the telecommunication network. The communication management controller 207 is an innovative hardware that is realized through the physical implementation of both analog and digital circuits, including logic gates, integrated circuits, microprocessors, microcontrollers, memory circuits, passive and active electronic components, as well as optical components. The communication management controller 207 of the UE 101 receives at least one RRC reconfiguration message or RRC release message from a network apparatus, when the UE 101 is in a RRC CONNECTED state. The RRC reconfiguration message or RRC release message comprises multicast MBS (Multicast Broadcast Service) Control Channel (MCCH) channel configuration information and one or more multicast MBS Radio Bearer (MRB) configurations that can be received in RRC INACTIVE state. Further, the communication management controller 207 transits from RRC CONNECTED state to the RRC INACTIVE state. Further, the communication management controller 207 configures a multicast MCCH channel using the multicast MCCH channel configuration information; Furthermore, the communication management controller 207 receives the MCCH information and the one or more multicast MRB configurations through a multicast MBS Control Channel (MCCH) channel. The MCCH information comprises an indication about presence or absence of the one or more multicast MRB configurations and a change in the one or more multicast MRB configurations. Thereafter, the communication management controller 207 determines whether a change in the one or more multicast MRB configurations is indicated. When the change in the one or more multicast MRB configurations is indicated in the multicast MCCH information, the communication management controller 207 obtains the one or more multicast MRB configurations provided in the multicast MCCH by mapping with the stored one or more multicast MRB configurations and continues multicast reception in the RRC INACTIVE state using the one or more multicast MRB configurations. Also, when the change in the one or more multicast MRB configurations is not indicated in the multicast MCCH information, the communication management controller 207 continues to receive the multicast reception in the RRC INACTIVE state using the stored one or more multicast MRB configurations.

In an embodiment, when the UE 101, which is capable and/or configured to receive multicast in RRC INACTIVE, is having an activated session in the RRC CONNECTED and is released to RRC INACTIVE state by the network apparatus 102 (e.g., by a RRC Release with SuspendConfig message), the communication management controller 207 of the UE 101 maintains the relevant one or more multicast MRB configurations. Particularly, the communication management controller 207 can store set of parameters included in the one or more multicast MRB configurations that are needed to receive multicast session in the RRC INACTIVE. Further, the communication management controller 207 continues to receive multicast session in the RRC INACTIVE state and the UE 101 does not suspend the one or more multicast MRB configurations when the UE 101 transits to RRC INACTIVE state. The multicast MRB configuration in accordance with the disclosure, a set of configuration parameters introduced in 3GPP specification are described as a Table 1:

TABLE 1
2> suspend all multicast MRB(s) associated with multicast session(s)
not configured to receive in RRC INACTIVE;
2> indicate PDCP suspend to lower layers of all DRBs and multicast
MRBs associated with multicast session(s) not configured to receive in
RRC INACTIVE;

In an embodiment, the one or more multicast MRB configurations that are at least one of not released, configured, stored, not suspended can be explicitly configured or signaled to the UE 101 to receive the multicast session in the RRC INACTIVE state. The multicast MRB configuration in accordance with the disclosure, a set of configuration parameters introduced in 3GPP specification are described as a Table 2.

TABLE 2

```
2> if the multicastConfigInactive is configured:
  3> if the multicast PTM configuration is provided for a
multicast session for which the UE is not indicated to stop
monitoring the G-RNTI and the UE selects the same cell as the
one on which it received RRCRelease:
    4>  apply the multicast PTM configuration as
  specified in 5.x.3;
    4>  monitor the Multicast MCCH-RNTI as
  specified in 5.x.2;
```

In an embodiment, MCCH channel provides the one or more multicast configuration for the UEs receiving or interested to receive multicast in RRC INACTIVE state. The configurations includes the configurations for the MRBs for the multicast sessions that are activated and transmitted in the multicast area (e.g. a cell or a group of cells or a Radio Access Network (RAN) based Notification Area (RNA)).

In an embodiment, the MCCH channel responsible for providing one or more multicast MRB configurations may coincide with the legacy MCCH channel that furnishes broadcast MRB/session configurations, commonly referred to as the MBS-Broadcast-Configuration message. To differentiate the multicast MRB configurations from the broadcast configurations, a separate message called the MBS-Multicast-Configuration message may be employed. As a result, the MCCH channel can contain at least one message that includes either the MBS-Broadcast-Configuration message or the MBS-Multicast-Configuration message, or both. Additionally, an identifier field, bit, or bitmap may be incorporated into at least one of the MCCH information transmitted over the MCCH channel, specifically for MCCH change notification. Through DCI scheduling, the MCCH change notification can indicate the presence or absence of the MBS-Broadcast-Configuration message and/or the MBS-Multicast-Configuration message on the MCCH channel. This feature enables UE 101 to ascertain the presence or absence of the relevant message, and to decode and receive MCCH only when the relevant message is present.

In an embodiment, the MCCH channel responsible for providing one or more MRB multicast configurations may differ from the traditional MCCH channel (termed as broadcast MCCH channel) that provides configurations for broadcast MRBs/sessions. The configuration parameters for the new MCCH channel (also termed as multicast MCCH channel in the disclosure) may be furnished to the UE 101 in the RRC CONNECTED state. For instance, the configuration parameters may be provided when the UE 101 joins at least one multicast session in RRC CONNECTED, but before transitioning to RRC INACTIVE. This guarantees that the configuration for the multicast MCCH channel is solely obtained by UEs 101 that have joined a multicast session in RRC CONNECTED. The channel configuration parameters for multicast MCCH channel that provides one or more multicast MRB configurations comprises at least one parameter of multicast MCCH modification period, repetition period, start offset (indicates slot in which the MCCH transmission window starts), and duration.

In accordance with the embodiments, a description of the 3GPP specification for the multicast MCCH transmission is provided. The multicast MCCH information (i.e. information transmitted in messages sent over multicast MCCH) is transmitted periodically to the UE 101, using a configurable repetition period and within a configured transmission window. MCCH transmissions (and the associated radio resources and MCS) are indicated via the Physical Downlink Control Channel (PDCCH) addressed to Multicast MCCH-RNTI. PDCCH monitoring occasion(s) for the multicast MCCH transmission are determined according to the common search space indicated by searchspaceMulticastMCCH. In case that searchspaceMulticastMCCH is set to zero, PDCCH monitoring occasions for the multicast MCCH message reception in the multicast MCCH transmission window are the same as PDCCH monitoring occasions for system information block 1 (SIB1) where the mapping between PDCCH monitoring occasions and synchronization signal block (SSB)s is specified in TS 38.213 [13]. In case that searchspaceMulticastMCCH is not set to zero, PDCCH monitoring occasions for the multicast MCCH message are determined based on search space indicated by searchspaceMulticastMCCH. PDCCH monitoring occasions for the multicast MCCH message which are not overlapping with UpLink symbols (determined according to tdd-UL-DL-ConfigurationCommon) are sequentially numbered from one in the multicast MCCH transmission window. The [xxN+K]th PDCCH monitoring occasion for the multicast MCCH message in the multicast MCCH transmission window corresponds to the Kth transmitted SSB, where x=0, 1, . . . X−1, K=1, 2, . . . N, N is the number of actual transmitted SSBs determined according to ssb-PositionsInBurst in SIB1 and X is equal to CEIL (number of PDCCH monitoring occasions in multicast MCCH transmission window/N). The actual transmitted SSBs are sequentially numbered from one in ascending order of their SSB indexes. The UE 101 assumes that, in the multicast MCCH transmission window, PDCCH for a multicast MCCH information is transmitted in at least one PDCCH monitoring occasion corresponding to each transmitted SSB and thus the selection of SSB for the reception multicast MCCH messages is up to UE 101 implementation.

In accordance with the embodiments of the disclosure, a description of the 3GPP specification for the change of MCCH information is provided. change of the MCCH information only occurs at specific radio frames, i.e. the concept of a modification period is used. Within a modification period, the same multicast MCCH information may be transmitted a number of times, as defined by its scheduling (which is based on a repetition period). When the network apparatus 102 changes some of the multicast MCCH information, the network apparatus notifies the UEs 101 about the change in the MCCH information. The MCCH information starting from the beginning of the multicast MCCH modification period via PDCCH which schedules the multicast MCCH in every repetition in that modification period. Upon receiving the change notification, a UE 101 receives MBS multicast service(s) in RRC INACTIVE and acquires the new multicast MCCH information starting from the same slot. The UE 101 applies the previously acquired multicast MCCH information until the UE 101 acquires the new multicast MCCH information.

In accordance with the embodiments of the disclosure, a description of the 3GPP specification for multicast MCCH message is provided. A multicast MCCH information a RRC message that may be sent from the network apparatus 102 to the UE 101 on the multicast MCCH channel. The multicast MCCH message is described as a Table 3.

TABLE 3
MulticastMCCH-Message-r18 ::= SEQUENCE {

| | |
|---|---|
| message | MulticastMCCH-MessageType-r18 |

}
MulticastMCCH-MessageType-r18 ::= CHOICE {

| | |
|---|---|
| c1 | CHOICE { |

mbsMulticastConfiguration-r18 MBSMulticastConfiguration-r18,

| | |
|---|---|
| spare1 | NULL |

```
  },
  messageClassExtension  SEQUENCE { }
}
```

In accordance with the embodiments, a description of the 3GPP specification for the acquisition of multicast MCCH is provided. The UE 101 applies the MCCH information acquisition procedure to obtain one or more multicast MRB configurations from the network apparatus 102. This procedure is exclusive to UEs 101 that have been configured to receive multicast MRB configurations and corresponding multicast services while in RRC INACTIVE state.

In accordance with the embodiments, a description of the 3GPP specification for the acquisition of multicast MCCH is provided. In case that the UE 101 is configured to receive MBS multicast services in RRC INACTIVE, the UE 101 applies the multicast MCCH information acquisition procedure for Point-To-Multipoint (PTM) configuration update and upon reselection to a new cell providing SIBx. The UE 101 that is receiving MBS multicast services in RRC INACTIVE shall apply the MCCH information acquisition procedure upon receiving a notification that the multicast MCCH information has changed.

In accordance with the embodiments of the disclosure, a description of the 3GPP specification for the acquisition of multicast MCCH is provided. In the absence of any explicit specification to the contrary, the MCCH information acquisition process shall overwrite any previously stored multicast MCCH information. Additionally, it is important to note that the delta configuration cannot be applied to multicast MCCH information. Should a field be absent in such information, the UE 101 must discontinue its use.

In accordance with the embodiments, a description of the 3GPP specification for the conditions of acquiring multicast MCCH is provided. The UE 101 configured to receive an MBS multicast service subject to certain configuration conditions provided as a Table 4:

```
TABLE 4
1>  if the procedure is triggered by a multicast MCCH information
change notification:
  2>  start acquiring the MBSMulticastConfiguration message on
multicast MCCH in the concerned cell from the slot in which the change
notification was received;
1>  if the UE moves to a different cell providing SIBx; or
1>  if the UE receives RRCRelease configuring the UE to receive MBS
multicast in RRC INACTIVE which does not include PTM configuration
for at least one multicast session for which the UE is not indicated to stop
monitoring the G-RNTI:
  2>  acquire the MBSMulticastConfiguration message on
multicast MCCH in the concerned cell at the next repetition period.
```

In an embodiment, a mixed approach for one or more multicast MRB configurations is provided. The mixed approach includes both the dedicated signaling (e.g. RRC reconfiguration message and/or RRC release with suspend config) and broadcast signaling (e.g. multicast MCCH channel) to carry the one or more multicast MRB configurations. The UE 101 in RRC CONNECTED state receives the one or more multicast MRB configurations through the dedicated signaling and the UE 101 in RRC INACTIVE receives the multicast configuration through broadcast signaling (e.g. multicast MCCH channel).

In an embodiment, a mixed approach is utilized for one or more multicast MRB configurations. This approach ensures that both the dedicated signaling and multicast MCCH channel provide comprehensive signaling for the relevant multicast MRB configurations, which are necessary for delivering multicast sessions to the UE 101 in both the RRC CONNECTED and RRC INACTIVE states.

In an embodiment, the mixed approach for providing one or more multicast MRB configurations involves the UE 101 utilizing dedicated signaling to provide complete signaling of the multicast MRB configurations relevant to the multicast sessions being delivered in the RRC CONNECTED state. Additionally, when in the RRC INACTIVE state, the UE 101 receives multicast MCCH information through the multicast MCCH channel, which provides delta signaling of the multicast MRB configurations relevant to the multicast sessions being delivered in the RRC INACTIVE state.

The UE 101 receives multicast MRB configurations in the RRC CONNECTED state through dedicated signaling, with the delta signaling only including updated multicast configurations and changed parameters. Furthermore, the UE 101 can receive delta signaling and be configured with updated multicast MRB configurations in the RRC INACTIVE state itself, avoiding the need to switch to the RRC CONNECTED state for configuration.

While in the RRC INACTIVE state, the UE 101 can continue to receive multicast sessions and updated multicast MRB configurations through the MCCH channel. This approach ensures efficient signaling and allows only those UEs 101 that have joined the multicast session in the RRC CONNECTED state and can receive multicast sessions in the RRC INACTIVE state to access the multicast session. However, UEs 101 that have not joined the multicast session in the RRC CONNECTED state will not be able to directly access the multicast session in the RRC INACTIVE state.

In an embodiment, the MCCH information may comprise a notification of a change in one or more multicast MRB configurations. This notification can be received through DownLink Control Information (DCI). The indication of a change in the MRB configurations is conveyed through at least one bit (e.g. using a single bit), with bit 0 indicating no change and bit 1 indicating a change. Based on this indication, the UE 101 can pre-determine the presence, absence, or change of the multicast MRB configurations, session deactivation, change of neighboring cell information and decode and receive the multicast MCCH information only when it is relevant.

In an embodiment, when the mixed approach is deployed, a multicast configuration identity (e.g. Multicast-INACTIVE-CONFIG-ID) is indicated in the dedicated signaling for each of the multicast session and/or G-RNTI/G-CS-RNTI specific configuration for the UE 101. The multicast configuration identity can be uniquely assigned for each of the multicast session. The multicast configuration identity can include at least one of G-RNTI/G-CS-RNTI specific configurations for the relevant UEs 101. Further, the UE 101 identifies and stores the multicast configuration identity for the one or more multicast session while receiving the dedicated signaling message in the RRC CONNECTED state. Further, the UE 101 can use the stored multicast configuration identity to identify the one or more multicast session, when the UE 101 is in the RRC INACTIVE state. For example, in case that there are 100 multicast sessions in a cell or a multicast coverage area or RNA, the network apparatus 102 may assign unique multicast configuration identity to each of the multicast session. The UE 101 identifies the relevant multicast session using the multicast configuration identity included in the multicast MCCH information along with the one or more multicast MRB configurations received through the multicast MCCH channel. Thus, the usage of the multicast configuration identity can allow only the authorized UE 101 that have joined session in the RRC CONNECTED state to receive the one or more multicast MRB configurations through the MCCH when in RRC INACTIVE state. Similarly, in delta signaling, the usage of the multicast configuration identity allows the authorized UE 101 to receive the updated one or more multicast MRB configurations by mapping the multicast configuration identity and/or G-RNTI/G-CS-RNTI specific configurations with the one or more stored multicast MRB configurations.

In an embodiment introduces a newly defined parameter known as the multicast configuration identity, which addresses a sufficient value range capable of accommodating numerous multicast sessions offered by the network within the cell, multicast coverage area, or RNA.

In an embodiment, G-RNTIs, G-CS-RNTIs, or TMGIs can serve as multicast configuration identity for multicast session, along with G-RNTI/G-CS-RNTI specific configurations. The multicast MRB configuration in accordance with disclosure, a set of configuration parameters introduced in 3GPP specification are described as a Table 5:

TABLE 5

| MBS-SessionInfoMulticast-r18 ::= SEQUENCE { | |
|---|---|
| mbs-SessionId-r18 | TMGI-r17, |
| g-RNTI-r18 | RNTI-Value |
| OPTIONAL, -- Need R | |
| mrb-ListMulticast-r18 | MRB-ListMulticast-r18 |
| OPTIONAL, -- Need R | |
| mtch-SchedulingInfo-r18 | DRX-ConfigPTM-Index-r17 |
| OPTIONAL, -- Need S | |
| mtch-NeighbourCell-r18 | BIT STRING |
| (SIZE(maxNeighCellMBS-r17)) | OPTIONAL, -- Need S |
| pdsch-ConfigIndex-r18 | PDSCH-ConfigIndex-r17 |
| OPTIONAL, -- Need S | |
| mtch-SSB-MappingWindowIndex-r18 MTCH-SSB- | |
| MappingWindowIndex-r17 | OPTIONAL, -- Cond MTCH- |
| Mapping | |
| thresholdIndex-r18 | INTEGER |
| (0..maxNrofThresholdMBS-r18) | OPTIONAL, -- Need R |
| pdcp-SYNC-Indicator-r18 | ENUMERATED {true} |
| OPTIONAL, -- Cond RRCRelease | |
| stopMonitoringRNTI-r18 | ENUMERATED {true} |

OPTIONAL -- Need R
}

In an embodiment, G-RNTIs or G-CS-RNTIs or TMGIs can be mapped to some other identities so as to hide the G-RNTIs or G-CS-RNTIs or TMGIs in the one or more multicast MRB configurations provided by the multicast MCCH in order to address privacy or security concerns.

In an embodiment, G-RNTIs, G-CS-RNTIs, or TMGIs may be mapped to shorter identities to decrease the signaling size required for the multicast MRB configurations provided by the multicast MCCH. This results in more efficient signaling. Shorter identities can be utilized in the multicast MCCH to identify the multicast MRB configurations of the multicast sessions or the related G-RNTIs, G-CS-RNTIs, or TMGIs. The shorter identities are included in the dedicated signaling for the multicast sessions and/or G-RNTI/G-CS-RNTI specific configurations.

In an embodiment, MCCH information can be provided in the form of MCCH based group notification approach. The group notification can include, but not limited to at least one of an identifier field, bits, a bit map to indicate the presence or absence of the one or more multicast MRB configurations, the one or more multicast MRB configurations, multicast session activation, multicast session deactivation (also represented by stopMonitoringRNTI field), multicast session release, multicast session configuration change, need for a RRC state change for the multicast session, congestion indication. The group notification for the one or more multicast session can be notified as at least one of a list of the TMGIs or the multicast configuration identities or G-RNTIs/G-CS-RNTIs and a bit/bitmap/field/identifier for the notification type (e.g. activation, deactivation, release, RRC state change, congestion). Further, in an embodiment, the multicast MCCH change notification DCI or the DCI scheduling the multicast MCCH may include one or more bits to indicate the presence/absence or the type of group notification information carried in the multicast MCCH.

In an embodiment, multicast MCCH also provides the neighbor cell list that is a list of cells providing one or more of the same set of the multicast sessions as available or provided in the current cell. The multicast MRB configuration in accordance with disclosure, a set of configuration parameters introduced in 3GPP specification are described as a Table 6:

```
TABLE 6
Signalling radio bearer: N/A
RLC-SAP: UM
Logical channel: multicast MCCH
Direction: Network to UE
  -- ASN1START
  -- TAG-MBSMULTICASTCONFIGURATION-START
  MBSMulticastConfiguration-r18 ::= SEQUENCE {
```

| | |
|---|---|
| criticalExtensions | CHOICE { |

```
        mbsMulticastConfiguration-r18
    MBSMulticastConfiguration-r18-IEs,
```

| | |
|---|---|
| criticalExtensionsFuture | SEQUENCE { } |

```
      }
    }
    MBSMulticastConfiguration-r18-IEs ::= SEQUENCE {
```

| | |
|---|---|
| mbs-SessionInfoList-r18 | MBS- |

| | |
|---|---|
| SessionInfoListMulticast-r18 | OPTIONAL, |

-- Need R

| | |
|---|---|
| mbs-NeighbourCellList-r18 | MBS- |

| | |
|---|---|
| NeighbourCellList-r17 | OPTIONAL, |

-- Need S

| | |
|---|---|
| drx-ConfigPTM-List-r18 | SEQUENCE (SIZE |

```
  (1..maxNrofDRX-ConfigPTM-r17)) OF DRX-ConfigPTM-r17
    OPTIONAL, -- Need R
```

| | |
|---|---|
| pdsch-ConfigMTCH-r18 | PDSCH-ConfigBroadcast- |
| r17 | OPTIONAL, -- Need S |

mtch-SSB-MappingWindowList-r18 MTCH-SSB-

| | |
|---|---|
| MappingWindowList-r17 | OPTIONAL, - |

- Need R

| | |
|---|---|
| thresholdMBS-List-r18 | SEQUENCE (SIZE |

```
  (1..maxNrofThresholdMBS-r18)) OF ThresholdMBS-r18
    OPTIONAL, -- Need R
```

| | |
|---|---|
| lateNonCriticalExtension | OCTET STRING |

OPTIONAL,

| | |
|---|---|
| nonCriticalExtension | SEQUENCE { } |

```
    OPTIONAL
    }
```

| | |
|---|---|
| ThresholdMBS-r18 ::= | CHOICE { |
| rsrp-r18 | RSRP-Range, |
| rsrq-r18 | RSRQ-Range |

}

The field “mbs-NeighbourCellList” includes a list of neighbor cells providing one or more MBS multicast services for RRC INACTIVE that are provided by the current cell. This field is used by the UE 101 together with mtch-NeighbourCell field signaled for each MBS session in the corresponding MBS-SessionInfo. When an empty mbs-NeighbourCellList list is signaled, the UE 101 shall assume that MBS multicast services signaled in mbs-SessionInfoList in the MBSMulticastConfiguration message are not provided in any neighbor cell. When a non-empty mbs-NeighbourCellList is signaled, the current serving cell does not provide information about MBS multicast services of a neighbor cell that is not included in mbs-NeighbourCellList, i.e., the UE 101 cannot determine the presence or absence of an MBS multicast service of a neighbor cell that is absent. When the field mbs-NeighbourCellList is absent, the current serving cell does not provide information about MBS multicast services in the neighboring cells, i.e. the UE 101 cannot determine the presence or absence of an MBS multicast service in neighboring cells based on the absence of this field.

The field mbs-sessioninfolist provides the configuration of each MBS session provided by MBS multicast in the current cell.

The field pdsch-ConfigMTCH provides parameters for acquiring the PDSCH for MTCH. When this field is absent, the UE 101 shall use parameters in pdsch-ConfigMCCH in SIBx to acquire the PDSCH for multicast MTCH.

The field thresholdMBS-List provides a list of reception quality thresholds for RRC connection resume for the UE 101 receiving multicast in RRC INACTIVE.

In an embodiment, the UE 101 which is interested or configured to receive multicast session in RRC INACTIVE state performs multicast MCCH acquisition when the UE 101 transits from RRC CONNECTED to RRC INACTIVE, when it performs a cell selection/reselection to a cell within the multicast coverage area or RNA.

In an embodiment, the UE 101 which has acquired the one or more multicast MRB configurations from multicast MCCH in RRC INACTIVE, releases the one or more multicast MRB configurations when the UE 101 performs at least one of a cell selection or reselection to a cell outside the multicast coverage area or RNA, when the UE 101 transits to RRC IDLE state upon RRC connection release, when the UE 101 transits to RRC_CONENCTED state upon RRC connection resume, and when the UE 101 selects or reselects a cell that does not support multicast in RRC INACTIVE. Further, in an embodiment, UE 101 sends a RRC connection request message or a RRC connection resume request message in order to transit to RRC CONNECTED state and continues to receive multicast.

In an embodiment herein, the RRC Release with suspend config provides the one or more multicast MRB configurations for the multicast MRB(s) (termed as mbs-multicast-InactiveConfig) that is to be used for multicast reception in the RRC INACTIVE. Further, the UE 101 can store mbs-multicast-InactiveConfig in Inactive As context. The suspendconfig in accordance with disclosure, a set of configuration parameters introduced in 3GPP specification are described as a Table 7:

TABLE 7

| SuspendConfig ::= | SEQUENCE { |
|---|---|
| fullI-RNTI | I-RNTI-Value, |
| shortI-RNTI | ShortI-RNTI-Value, |
| ran-PagingCycle | PagingCycle, |
| ran-NotificationAreaInfo RAN-NotificationAreaInfo | |
| OPTIONAL, -- Need M | |
| t380 | PeriodicRNAU-TimerValue |
| OPTIONAL, -- Need R | |
| nextHopChainingCount | NextHopChainingCount, ..., |
| [[ | |
| sl-ServingCellInfo-r17 | SL-ServingCellInfo-r17 |
| OPTIONAL, -- Cond L2RemoteUE | |
| sdt-Config-r17 | SetupRelease {SDT-Config-r17 |
| } | |
| OPTIONAL, -- Need M | |
| srs-PosRRC-InactiveConfig-r17 SRS-PosRRC | |
| InactiveConfig-r17 | |
| OPTIONAL, -- Need M | |
| ran-ExtendedPagingCycle-r17 ExtendedPagingCycle-r17 | |
| OPTIONAL -- Need R | |
| mbs-multicast-InactiveConfig-r18 MBS-multicast-InactiveConfig- | |
| r18 | |
| ]] | |
| } | |
| mbs-multicast-InactiveConfig-r18 ::= SEQUENCE { | |
| mbs-InactiveConfig-r18 MBS-InactiveConfig-r18, | |
| mbs-InactiveMacConfig-r18 MBS-InactiveMacConfig-r18 | |
| mbs-InactivePhyConfig-r18 MBS-InactivePhyConfig-r18 | |
| } | |
| MBS-InactiveConfig-r18 ::= SEQUENCE{ | |
| mrb-ToAddModList MRB-ToAddModList | |
| OPTIONAL, | |
| mrb-ToReleaseList MRB-ToReleaseList OPTIONAL | |
| } | |
| MBS-InactiveMacConfig-r18::= SEQUENCE{ | |
| g-RNTI-ConfigToAddModList | SEQUENCE (SIZE |
| (1..maxG-RNTI)) | |
| OF MBS-RNTI-SpecificConfig OPTIONAL, | |
| g-RNTI-ConfigToReleaseList | SEQUENCE (SIZE |
| (1..maxG-RNTI)) OF | |
| MBS-RNTI-SpecificConfigId OPTIONAL, | |
| g-CS-RNTI-ConfigToAddModList SEQUENCE (SIZE | |
| (1..maxG-CS-RNTI)) OF MBS-RNTI-SpecificConfig OPTIONAL, | |
| g-CS-RNTI-ConfigToReleaseList | SEQUENCE (SIZE |
| (1..maxG-CSRNTI)) OF MBS-RNTI-SpecificConfigId OPTIONAL, | |
| ]] | |
| } | |
| MBS-RNTI-SpecificConfig ::= SEQUENCE { | |
| mbs-RNTI-SpecificConfigId | MBS-RNTI- |

```
SpecificConfigId,
    groupCommon-RNTI CHOICE {
      g-RNTI RNTI-Value,
      g-CS-RNTI RNTI-Value
},
drx-ConfigPTM SetupRelease {DRX-ConfigPTM}
OPTIONAL, -- Need M
    pdsch-AggregationFactorMulticast ENUMERATED {n2,
n4, n8}
OPTIONAL -- Cond G-RNTI
}
Multicast-INACTIVE-CONFIG-ID::=INTEGER  (0..maxINACTIVE-
Config-1)
MBS-RNTI-SpecificConfigId ::= INTEGER (0..maxG-RNTI-1)
}
MBS-InactivePhyConfig-r18::=SEQUENCE{
Pdcch-config SetupRelease {PDCCH-Config} OPTIONAL, -- Need M
Pdsch-config SetupRelease {PDSCH-Config} OPTIONAL, --
Need M
}
```

The MBS-multicast-InactiveConfig field description:

The MBS-InactiveMacConfig-r18 can be used to configure MBS radio bearers for multicast reception in the RRC_IANCTIVE state.

The MBS-InactiveMacConfig-r18 can be used to configure MAC parameters, including DRX, for multicast reception in RRC INACTIVE state.

The MBS-InactivePhyConfig-r18 can be used to configure cellgroup specific L1 parameters for multicast in RRC INACTIVE state.

In an embodiment, the UE 101 retains one or multiple pertinent MRB configurations from the RRC reconfiguration message, enabling the multicast MRBs to receive multicast sessions in RRC INACTIVE. This includes configurations of multicast MRBs that are currently activated in RRC CONNECTED. Additionally, the UE 101 furnishes the relevant MRB configurations for multicast MRB(s) with the RRC Release with Suspendconfig message, allowing them to receive multicast sessions in RRC INACTIVE. This encompasses configurations of multicast MRBs that are presently deactivated in RRC CONNECTED.

In an embodiment, the network apparatus 102 can inform or configure the UE 101 regarding the coverage area of the multicast session. This can include details such as the cells or cell-list that provide the multicast session in RRC INACTIVE mode. Moreover, the UE 101 can continue to maintain and utilize the mbs-multicast-InactiveConfig across these cells, even during cell reselection. However, in the event of cell reselection to a different cell that falls outside the informed cell list or coverage area, the UE 101 must release the mbs-multicast-InactiveConfig in case that it was previously configured.

In an embodiment herein, in case that the RRCRelease message with SuspendConfig includes mbs-multicast-InactiveConfig, when the UE 101 enters RRC INACTIVE, the UE 101 performs cell selection or reselection such that the UE 101 can camp on or select the same current cell providing multicast services. Thus, the UE 101 can prioritize the current cell.

In an embodiment, the UE 101 skips the cell selection step and selects the same current cell for camping and continuing multicast services.

In an embodiment, the UE 101 can prioritize cells in the coverage area of the multicast session (e.g., cells or cell-list providing the multicast session in RRC INACTIVE state and the UE 101 can continue to retain and/or use the mbs-multicast-InactiveConfig across these cells e.g. when there is cell reselection taking place) when the UE 101 performs cell selection or cell re-selection. In case that the selected or re-selected cell is in the coverage area of the multicast session, the UE 101 transits to RRC CONNECTED.

In an embodiment, the information on the coverage area of the multicast session can be updated (changed). The network apparatus 102 can indicate the update of the coverage area via the MCCH. In another embodiment, the network apparatus 102 can ask the UE 101 to transit to RRC CONNECTED for update of the coverage area.

In an embodiment herein, when the UE 101 that is capable or configured to receive multicast in RRC INACTIVE, receives ‘release’ for relevant multicast session(s) e.g., through group notification (group paging or multicast MCCH) from network apparatus. Further, the UE 101 again removes or discards the stored one or more multicast MRB configurations of the relevant multicast MRB(s) and stops monitoring for group notification at least for relevant TMGI(s).

In an embodiment herein, when the UE 101 that is capable or configured to receive multicast in RRC INACTIVE, receives ‘release’ for relevant multicast session(s) e.g., through group notification (group paging or multicast MCCH) from network in RRC INACTIVE, the UE 101 removes or discards the configuration of the relevant multicast MRB(s) as received mbs-multicast-InactiveConfig included in SuspendConfig (i.e. through RRCRelease with SuspendConfig message while UE was in RRC CONNECTED) and stops monitoring for group notification or MCCH for relevant TMGI(s).

In an embodiment herein, the UE 101 that is configured to receive multicast in RRC INACTIVE, monitors for group notification (group paging or multicast MCCH) in RRC INACTIVE state for at least one of session activation, deactivation and release, irrespective of Paging Early Indication (PEI), that indicates whether there is presence or not of paging for the sub-group associated with the UE 101.

FIG. 2B is a block diagram that illustrates a network apparatus for configuring the UE for multicast reception in the telecommunication network, according to an embodiment of the disclosure.

Referring to FIG. 2B, the network apparatus 102 includes a processor 209, memory 211, an I/O interface 213 and a communication management controller 215. The network apparatus 102 refers to a set of devices or equipment's that are interconnected to form a network. The network apparatus 102 is capable of performing at least one of establishment of connection, management and functioning of communication networks. For example, the network apparatus can be, but not limited to a wireless communication network, access points, base station and a server. Further, the processor 209 of the network apparatus 102 communicates with the memory 211, the I/O interface 213 and the communication management controller 215. The processor 209 is configured to execute instructions stored in the memory 211 and to perform various processes. The processor 209 can include one or a plurality of processors, can be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

Further, the memory 211 of the network apparatus 102 includes storage locations to be addressable through the processor 209. The memory 211 is not limited to a volatile memory and/or a non-volatile memory. Further, the memory 211 can include one or more computer-readable storage media. The memory 211 can include non-volatile storage elements. For example, non-volatile storage elements can include magnetic hard discs, optical discs, floppy discs, flash memories, or forms of electrically programmable memories (EPROM) or electrically erasable and programmable (EEPROM) memories. The memory 211 can store the media streams such as audios stream, video streams, haptic feedbacks and the like. The memory 211 can store one or more multicast MRB configurations. In some embodiments, the memory 211 can store signaling messages transmitted by the UE 101.

The I/O interface 213 transmits the information between the memory 211 and external peripheral devices. The peripheral devices are the input-output devices associated with the network apparatus 102. The I/O interface 213 receives several information from the UE 101. The several information received from the UE 101 can include but not limited to multicast session identity associated with each of the one or more multicast session, MCCH information, MCCH configuration information.

The communication management controller 215 communicates with the I/O interface 213 and memory 211 for operating multicast services configured by the network apparatus 102 in the telecommunication network. The communication management controller 215 is an innovative hardware that is realized through the physical implementation of both analog and digital circuits, including logic gates, integrated circuits, microprocessors, microcontrollers, memory circuits, passive and active electronic components, as well as optical components. The communication management controller 215 of the network apparatus 102 transmits at least one RRC reconfiguration message or RRC release message, when the UE is in a RRC CONNECTED state. The RRC reconfiguration message or the RRC release message comprises at least one of multicast MBS (Multicast Broadcast Service) Control Channel (MCCH) channel configuration information and one or more multicast MBS Radio Bearer (MRB) configurations that can be received in a RRC INACTIVE state. Further, the communication management controller 215 transmits a MCCH information and the one or more multicast MRB configurations through a MCCH, when the UE is in a RRC INAACTIVE. The MCCH information comprises an indication about presence or absence of the one or more multicast MRB configurations and a change in the one or more multicast MRB configurations. Thereafter, the communication management controller 215 performs multicast MCCH transmission and multicast transmission to a group of UEs 101 configured to receive multicast session when the UE 101 is in the RRC INACTIVE state.

The network apparatus 102 transmits the MCCH information along with an indication about the change in the MCCH information. The network apparatus 102 provides the indication of the change in the MCCH information using a Downlink Control Information (DCI). The change in the MCCH information is indicated using a single bit. For example, the network apparatus 102 can include a bit “1”, to indicate the change in the MCCH information. Similarly, the network apparatus can include a bit “0”, to indicate that there is no change in the MCCH information. Based on the indication provided the UE 101 can either continue the multicast reception using the stored MCCH information or acquire the new MCCH information that is updated. The change in the MCCH information can include at least one of the change in the one or more multicast MRB configurations, presence or absence of the one or more multicast MRB configurations, a multicast session activation, multicast session deactivation, multicast session release, multicast session configuration change, need for a RRC state change for the multicast session, list of neighboring cells that has same multicast sessions, and congestion indication.

In an embodiment, when the mixed approach is deployed, the network apparatus 102 assigns a multicast configuration identity (e.g. Multicast-INACTIVE-CONFIG-ID) for each of the multicast session and is indicated in the dedicated signaling. The multicast configuration identity can include at least one of a G-RNTI, G-CS-RNTI, and TMGI. The multicast configuration identity can be uniquely assigned for each of the multicast session.

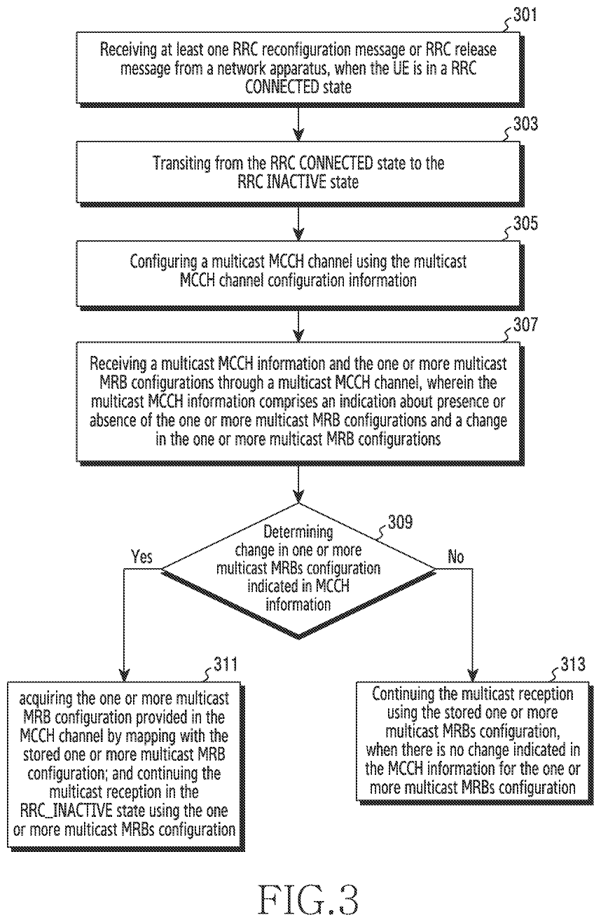

FIG. 3 is a flow diagram that illustrates a method to configure by a UE for multicast reception in a telecommunication network, according to an embodiment of the disclosure.

At operation 301, the UE 101 receives at least one RRC reconfiguration message or RRC release message from a network apparatus, when the UE is in a RRC CONNECTED state. The RRC reconfiguration message or the RRC release message comprises at least one of multicast MBS (Multicast Broadcast Service) Control Channel (MCCH) channel configuration information and one or more multicast MBS Radio Bearer (MRB) configurations that can be received in a RRC INACTIVE state. The UE 101 can configure the multicast MCCH for the multicast reception during RRC INACTIVE state using the multicast MCCH configuration information.

At operation 303, the UE 101 transits from the RRC CONNECTED state to the RRC INACTIVE state upon receiving the at least one RRC reconfiguration message or RRC release message (e.g. RRC Release with suspend Config).

At operation 305, the UE 101 configures a multicast MCCH channel using the multicast MCCH channel configuration information.

At operation 307, the UE 101 receives a multicast MCCH information and the one or more multicast MRB configurations through the multicast MCCH channel. The multicast MCCH information comprises an indication about presence or absence of the one or more multicast MRB configurations and a change in the one or more multicast MRB configurations. Also, the MCCH information comprises at least one of an identifier field, bits, a bit map to indicate the presence or absence of the one or more multicast MRB configurations, the one or more multicast MRB configurations, a multicast session activation, multicast session deactivation, multicast session release, multicast session configuration change, need for a RRC state change for the multicast session, list of neighboring cells that provides same multicast sessions as provided in the current serving cell, or congestion indication. Also, the UE 101 receives an indication for the change in the multicast MCCH information is received through the multicast MCCH change notification DCI message. Based on the indication provided in the multicast MCCH change notification DCI message the UE 101 acquires the multicast MCCH information received through the multicast MCCH.

At operation 309, the UE 101 determines whether a change in the multicast MCCH information indicated. The indication for the change in the multicast MCCH information is provided in the form of bit. The value “0” indicates that there are no changes in the multicast MCCH information. Similarly, the value “1” indicates that there is a change in the multicast MCCH information. Particularly, the change in the multicast MCCH information can be a change in the one or more MRB configurations or deactivation of multicast session or release of multicast session or change of neighboring cell information included in the MCCH information.

At operation 311, the UE 101 obtains the one or more multicast MRB configurations provided through the multicast MCCH channel by mapping with the stored one or more multicast MRB configurations, when the change in the multicast MCCH information is indicated. Upon obtaining, the UE 101 continues with the multicast reception in the RRC INACTIVE state using the one or more updated multicast MRB configurations included in the multicast MCCH information. Thus, the UE 101 is able to configure the updated multicast MRB configurations in the RRC INACTIVE state itself and without transiting from RRC INACTIVE to RRC CONNECTED state.

At operation 313, when there is no change in the multicast MCCH information is determined, then the UE 101 continues to the receive the multicast session in the RRC INACTICE state using the stored one or more multicast MRB configurations.

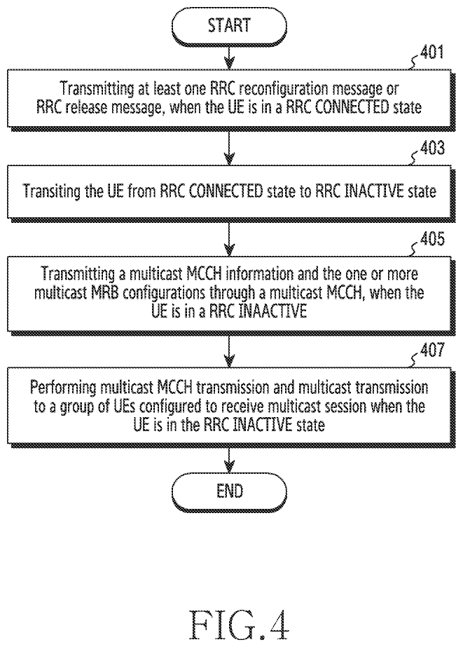

FIG. 4 is a flow diagram that illustrates a method for configuring by network apparatus UEs for multicast reception in a telecommunication network, according to the embodiment of the disclosure.

At operation 401, the network apparatus 102 transmits at least one RRC reconfiguration message or RRC release message when the UE 101 is in the RRC CONNECTED state. The RRC reconfiguration message or RRC release message is transmitted by the network apparatus 102 for reconfiguring and/or releasing the connection with the UE 101.

At operation 403, the network apparatus 102 transits the UE 101 from the RRC CONNECTED state to the RRC INACTIVE state.

At operation 405, the network apparatus 102 transmits a multicast MCCH information and the one or more multicast MRB configurations through the multicast MCCH, when the UE 101 is in RRC INACTIVE state. The UE 101 goes to RRC INACTIVE state upon receiving the RRC reconfiguration message or the RRC release message (e.g. RRC Release with suspend config). The UE 101 can continue the multicast reception based on the transmitted multicast MCCH information through the multicast MCCH channel.

At operation 407, the network apparatus 102 performs a multicast MCCH transmission and multicast transmission to group of UE 101 that are configured to receive the multicast session when the UE 101 is in the RRC INACTIVE state.

A method performed by a user equipment (UE) in a wireless communication system is provided. The method comprises receiving, from a base station, a radio resource control (RRC) release message including multicast broadcast services (MBS) configuration information and multicast control channel (MCCH) configuration information, wherein the MBS configuration information includes at least one of a list of neighboring cells, a group-radio network temporary identifier (G-RNTI), or an MBS session identity (ID), and the MCCH configuration information is associated with reception of a MBS multicast in an RRC inactive state and in case that a multicast session that the UE joined is not provided for the RRC inactive state in a current cell, performing an RRC connection resume.

The method further comprises receiving, from the base station, a first MCCH message including MBS configuration information, wherein the first MCCH message is configured with a modification period and a repetition period.

wherein, in case that the multicast session is deactivated or the MBS configuration information of the first MCCH message is changed, a notification is received from the base station.

wherein, in case that the MBS configuration information of the first MCCH message is changed or a cell is reselected, a second MCCH message is received from the base station.

The method further comprises receiving, from the base station while the UE is in the RRC inactive state, an MBS multicast data based on the MBS configuration information.

A user equipment (UE) in a wireless communication system is provided. The UE comprises a transceiver and a controller coupled with the transceiver and configured to receive, from a base station, a radio resource control (RRC) release message including multicast broadcast services (MBS) configuration information and multicast control channel (MCCH) configuration information, wherein the MBS configuration information includes at least one of a list of neighboring cells, a group-radio network temporary identifier (G-RNTI), or an MBS session identity (ID), and the MCCH configuration information is associated with reception of a MBS multicast in an RRC inactive state, and in case that a multicast session that the UE joined is not provided for the RRC inactive state in a current cell, perform an RRC connection resume.

The controller is further configured to receive, from the base station, a first MCCH message including MBS configuration information, wherein the first MCCH message is configured with a modification period and a repetition period.

Wherein, in case that the multicast session is deactivated or the MBS configuration information of the first MCCH message is changed, a notification is received from the base station.

Wherein, in case that the MBS configuration information of the first MCCH message is changed or a cell is reselected, a second MCCH message is received from the base station.

The controller is further configured to receive, from the base station while the UE is in the RRC inactive state, an MBS multicast data based on the MBS configuration information.

A method performed by a base station in a wireless communication system is provided. The method comprises transmitting, to a user equipment (UE), a radio resource control (RRC) release message including multicast broadcast services (MBS) configuration information and multicast control channel (MCCH) configuration information, wherein the MBS configuration information includes at least one of a list of neighboring cells, a group-radio network temporary identifier (G-RNTI), or an MBS session identity (ID), and the MCCH configuration information is associated with reception of a MBS multicast in an RRC inactive state and receiving, from the UE, a message for an RRC connection resume, in case that a multicast session that the UE joined is not provided for the RRC inactive state in a current cell.

The method further comprises transmitting, to the UE, a first MCCH message including MBS configuration information, wherein the first MCCH message is configured with a modification period and a repetition period.

Wherein, in case that the multicast session is deactivated or the MBS configuration information of the first MCCH message is changed, a notification is transmitted to the UE.

wherein, in case that the MBS configuration information of the first MCCH message is changed or a cell is reselected, a second MCCH message is transmitted to the UE.

The method further comprises transmitting, to the UE in the RRC inactive state, an MBS multicast data based on the MBS configuration information.

A base station in a wireless communication system is provided. The base station comprises a transceiver and a controller coupled with the transceiver and configured to transmit, to a user equipment (UE), a radio resource control (RRC) release message including multicast broadcast services (MBS) configuration information and multicast control channel (MCCH) configuration information, wherein the MBS configuration information includes at least one of a list of neighboring cells, a group-radio network temporary identifier (G-RNTI), or an MBS session identity (ID), and the MCCH configuration information is associated with reception of a MBS multicast in an RRC inactive state, and receive, from the UE, a message for an RRC connection resume, in case that a multicast session that the UE joined is not provided for the RRC inactive state in a current cell.

The controller is further configured to transmit, to the UE, a first MCCH message including MBS configuration information, wherein the first MCCH message is configured with a modification period and a repetition period.

Wherein, in case that the multicast session is deactivated or the MBS configuration information of the first MCCH message is changed, a notification is transmitted to the UE.

Wherein, in case that the MBS configuration information of the first MCCH message is changed or a cell is reselected, a second MCCH message is transmitted to the UE.

The controller is further configured to transmit, to the UE in the RRC inactive state, an MBS multicast data based on the MBS configuration information.

The various actions, acts, blocks, steps, or the like in the method is performed in the order presented, in a different order or simultaneously. Further, in some embodiments, some of the actions, acts, blocks, steps, or the like are omitted, added, modified, skipped, or the like without departing from the scope of the proposed method.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
receiving, from a base station, a radio resource control (RRC) release message including multicast broadcast services (MBS) configuration information and multicast control channel (MCCH) configuration information, wherein the MBS configuration information includes at least one of a list of neighboring cells, a group-radio network temporary identifier (G-RNTI), or an MBS session identity (ID), and the MCCH configuration information is associated with reception of a MBS multicast in an RRC inactive state; and
in case that a multicast session that the UE joined is not provided for the RRC inactive state in a current cell, performing an RRC connection resume.

2. The method of claim 1, further comprising:
receiving, from the base station, a first MCCH message including MBS configuration information,
wherein the first MCCH message is configured with a modification period and a repetition period.

3. The method of claim 2, wherein, in case that the multicast session is deactivated or the MBS configuration information of the first MCCH message is changed, a notification is received from the base station.

4. The method of claim 2, wherein, in case that the MBS configuration information of the first MCCH message is changed or a cell is reselected, a second MCCH message is received from the base station.

5. The method of claim 1, further comprising:
receiving, from the base station while the UE is in the RRC inactive state, an MBS multicast data based on the MBS configuration information.

6. A user equipment (UE) in a wireless communication system, the UE comprising:
a transceiver; and
a controller coupled with the transceiver and configured to:
receive, from a base station, a radio resource control (RRC) release message including multicast broadcast services (MBS) configuration information and multicast control channel (MCCH) configuration information, wherein the MBS configuration information includes at least one of a list of neighboring cells, a group-radio network temporary identifier (G-RNTI), or an MBS session identity (ID), and the MCCH configuration information is associated with reception of a MBS multicast in an RRC inactive state, and
in case that a multicast session that the UE joined is not provided for the RRC inactive state in a current cell, perform an RRC connection resume.

7. The UE of claim 6, wherein the controller is further configured to:
receive, from the base station, a first MCCH message including MBS configuration information,
wherein the first MCCH message is configured with a modification period and a repetition period.

8. The UE of claim 7, wherein, in case that the multicast session is deactivated or the MBS configuration information of the first MCCH message is changed, a notification is received from the base station.

9. The UE of claim 7, wherein, in case that the MBS configuration information of the first MCCH message is changed or a cell is reselected, a second MCCH message is received from the base station.

10. The UE of claim 6, wherein the controller is further configured to:
receive, from the base station while the UE is in the RRC inactive state, an MBS multicast data based on the MBS configuration information.

11. A method performed by a base station in a wireless communication system, the method comprising:
transmitting, to a user equipment (UE), a radio resource control (RRC) release message including multicast broadcast services (MBS) configuration information and multicast control channel (MCCH) configuration information, wherein the MBS configuration information includes at least one of a list of neighboring cells, a group-radio network temporary identifier (G-RNTI), or an MBS session identity (ID), and the MCCH configuration information is associated with reception of a MBS multicast in an RRC inactive state; and
receiving, from the UE, a message for an RRC connection resume, in case that a multicast session that the UE joined is not provided for the RRC inactive state in a current cell.

12. The method of claim 11, further comprising:
transmitting, to the UE, a first MCCH message including MBS configuration information,
wherein the first MCCH message is configured with a modification period and a repetition period.

13. The method of claim 12, wherein, in case that the multicast session is deactivated or the MBS configuration information of the first MCCH message is changed, a notification is transmitted to the UE.

14. The method of claim 12, wherein, in case that the MBS configuration information of the first MCCH message is changed or a cell is reselected, a second MCCH message is transmitted to the UE.

15. The method of claim 11, further comprising:
transmitting, to the UE in the RRC inactive state, an MBS multicast data based on the MBS configuration information.

16. A base station in a wireless communication system, the base station comprising:
a transceiver; and
a controller coupled with the transceiver and configured to:
transmit, to a user equipment (UE), a radio resource control (RRC) release message including multicast broadcast services (MBS) configuration information and multicast control channel (MCCH) configuration information, wherein the MBS configuration information includes at least one of a list of neighboring cells, a group-radio network temporary identifier (G-RNTI), or an MBS session identity (ID), and the MCCH configuration information is associated with reception of a MBS multicast in an RRC inactive state, and
receive, from the UE, a message for an RRC connection resume, in case that a multicast session that the UE joined is not provided for the RRC inactive state in a current cell.

17. The base station of claim 16, wherein the controller is further configured to:
transmit, to the UE, a first MCCH message including MBS configuration information,
wherein the first MCCH message is configured with a modification period and a repetition period.

18. The base station of claim 17, wherein, in case that the multicast session is deactivated or the MBS configuration information of the first MCCH message is changed, a notification is transmitted to the UE.

19. The base station of claim 17, wherein, in case that the MBS configuration information of the first MCCH message is changed or a cell is reselected, a second MCCH message is transmitted to the UE.

20. The base station of claim 16, wherein the controller is further configured to:
transmit, to the UE in the RRC inactive state, an MBS multicast data based on the MBS configuration information.
